(19) United States
(12) Patent Application Publication
(10) Pub. No.: US 2018/0131796 A1
(43) Pub. Date: May 10, 2018

(54) Mobile App to Update Phone Number Automatically

(71) Applicant: Sriram Varadhan, Portland, OR (US)

(72) Inventor: Sriram Varadhan, Portland, OR (US)

(21) Appl. No.: 15/619,492

(22) Filed: Jun. 11, 2017

Related U.S. Application Data
(60) Provisional application No. 62/418,935, filed on Nov. 8, 2016.

(51) Int. Cl. H04M 1/2745; H04L 29/08; H04M 1/725; G06F 17/30

(52) U.S. Cl. CPC H04M 1/274533; H04L 67/10; G06F 17/30386; G06F 17/30345; H04M 1/725

(57) ABSTRACT

A method is proposed for automatically updating the user's new phone number in all the contact's smartphones directly, without requiring an individual to manually update their contacts by text, email, or by using an application for maintaining of contact information. The Mobile Application provide flexibility for the user to change the phone number anytime and update the number directly in their contact's smartphone, Tablet or Computer. This invention can also assign a dummy number to one or more contacts, if the user decides the contact is no longer needed to store the user's phone number. Updating of the contacts with the automated process installed is more frequent.

### BACKGROUND

### Field of the Invention

The present invention relates to a Mobile Application to provide flexibility for the user to change the phone number anytime and update the new number directly in their contact's smartphone, Tablet or Computer. This invention can also assign a dummy number to one or more contacts, if the user decides the contact is no longer needed to store the user's phone number.

Aspects of the present invention relate more particularly to phone numbers and management systems and, more particularly, to managing phone numbers for mobile, Tablet or Computer devices.

### Description of the Related Art

In the past, people have maintained contact lists on paper. The proverbial “black book” is a good example of a list of individuals and their contact information. Unfortunately, it is not uncommon that upon attempting to contact someone one discovers that the information is no longer accurate. This is of tremendous inconvenience, especially during emergency or time limited situations. Unfortunately, the task of maintaining a large contact list current is often too onerous for the few times one needs to contact each individual.

Currently for all Global smartphone users, when there is a need to change a phone number for whatsoever reason such as, users receiving several junk calls, portability delay, other carrier offering cheap deals for new numbers, currently the smartphone user has to inform all the contacts by texting, auto texting, email or making a phone call to update the new phone number as replacement. There is a high chance for the contacts to miss storing the updated number of the user due to various reasons such as, delay in reading the text message, misread the message due to busy schedule, and sometimes accidentally deleting the text message. Due to these reasons, the contact might lose storing the user's new number in their smartphones.

Also, when the smartphone user is running low battery and cell phone reception issues, there is no facility for the smartphone user to change the number instantly, update the contacts, and continue receiving call and text messages for the designated cell phone number. When a particular contact is no longer in touch, the user doesn't have any idea about the present owner that uses the contact's phone number. Such users are no longer needed to store the user's number in their smartphones.

However, to Applicant's knowledge, there is no solution through a Mobile application available to automatically update registered user's new number directly in all their smartphone contact's phonebook. It is directed to such a system of single Mobile application that provides solution to all the above scenarios that the present invention is directed.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is related to Mobile application that provides the ability to all Global smartphone users to freely switch the phone number to a New phone number by updating the contacts directly without any message or email communication. Through the same Mobile application, the smartphone users have the ability to assign a dummy phone number to one or more contacts that are no longer in touch or no longer needed for various reasons. The invention also helps to assign a temporary number assigned by the user, and instantly update the contacts due to smartphone battery issues and cell phone network issues, so that it allows the contacts can continue reaching the user through the updated number through calls or text.

Another object of the invention relates to the mobile application contacts that will be instantly synchronized with the phone contacts, which will further be synchronized in other cloud servers such as Google drive and iCloud, depending on the user's settings in their smartphones. All the Global smartphone users will need to download this mobile application from Android or iOS Market, and have this installed in all their smartphone devices.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows process involved in new phone number update.

FIG. 2 shows Dummy Number Assignment to one or more Contacts in phonebook.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention provides a Mobile Application to provide flexibility for the user to change the phone number anytime and update the number directly in their contact's smartphone, Tablet or Computer. This invention can also assign a dummy number to one or more contacts, if the user decides the contact is no longer needed to store the user's phone number.

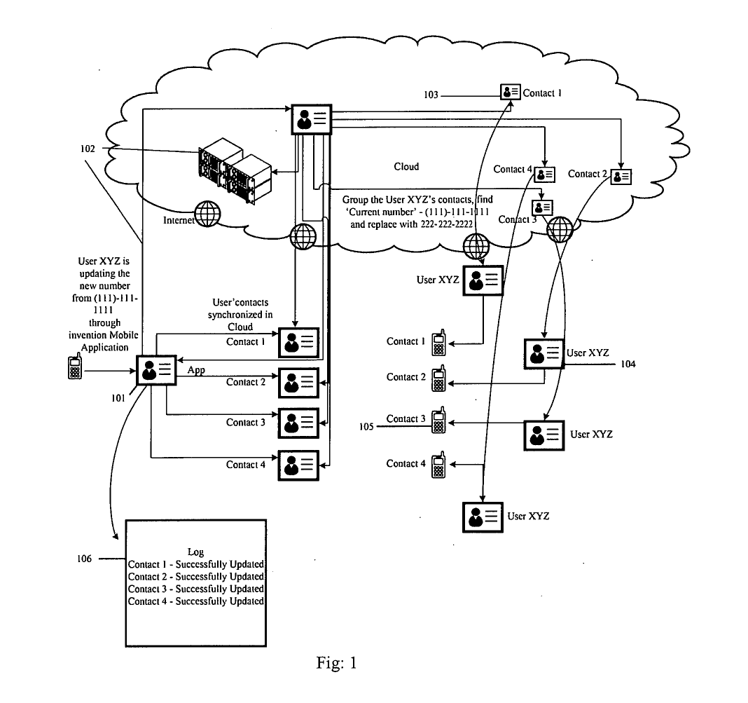

FIG. 1 is a pictorial representation of user ‘XYZ’ updating the new phone number. The user XYZ updates the new phone number (222)-222-2222 along with selecting the appropriate country code from the drop down menu, while being in Internet (WIFI (Wireless Networking), hotspot or data plan) 101. There will be a one-time password authentication generated by the database server and sent by the 3^{rd} party API service through text message. In the server database, the invention mobile application will identify the contacts of user ‘XYZ’ and group it 102. The invention mobile application will find the user ‘XYZ’'s existing number (111)-111-1111 in contacts, and replace with (222)-222-2222 in all the Contact's individual accounts for user ‘XYZ’'s number 103. The Contacts when connected to internet through their Smartphone, the user ‘XYZ’'s new number will be synchronized through the servers This will be controlled in the database through ‘0’ and ‘1’, wherein user's contacts with ‘0’ refers to ‘pending update’ for the contacts that are not in the internet range. ‘1’ refers to ‘successful update’ 104. Each contact's smartphone device will now display user ‘XYZ’s new phone number 105. User ‘XYZ’ will now be able to see the activity log of the phone number update through the Invention mobile application 106.

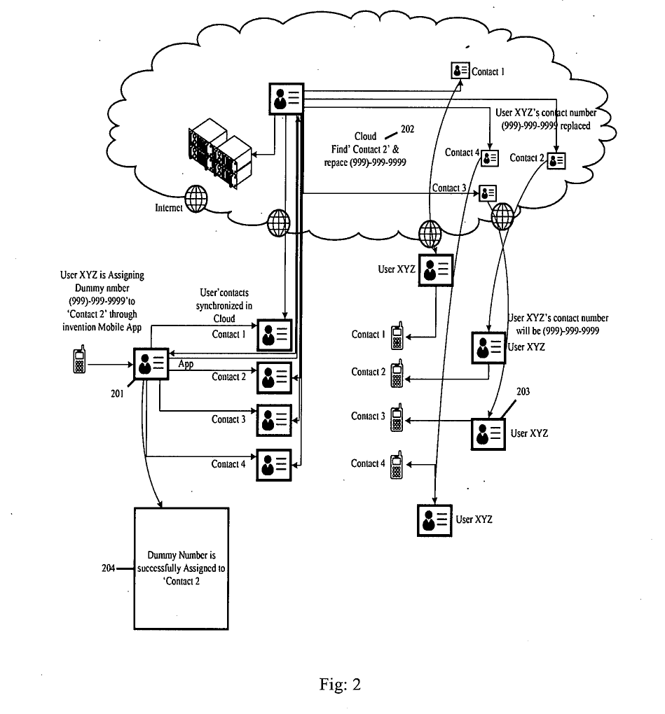

FIG. 2 is a pictorial representation of user ‘XYZ’ assigning a dummy number to one of the contact (Contact 2) in his smartphone device. The user XYZ selects ‘Contact 2’ through the invention mobile application and clicks the icon to assign dummy number. The dummy number 9999999999 is a hard coded dummy phone number within the invention mobile application. 201. In the server, the invention mobile application will search Contact 2's phone number and replace user XYZ's number as 9999999999 202. Through server database synchronization the Contact 2 will now see User XYZ's number as 9999999999 203. User XYZ will be able to see a log of the successful update of the dummy number to ‘Contact 2’ 204.

The functionality of the app will be simple every user needs to install the present invention mobile application in their smartphones, tablets or computers by registering their phone number. The present invention mobile application will be fully functional in the Internet. It can be either WIFI (Wireless Networking), Hotspot or data plan. It's a Cloud based mobile application which will use Phone number and name as logon credentials. An OTP (One Time Password) will be triggered every time the user installs and registers a new phone number. Once the user creates an account through the Mobile application, all the user's phonebook contacts will be imported and stored in the cloud server or data center.

Change Number—When the user decides to change the phone number, whether it is temporary or permanent, the user enters the new number in the ‘Change Number’ area in the mobile application, as specified in Diagram 1. An OTP (One Time Password) will be triggered to the new Number that the user assigned.

Upon OTP authentication, on a real time basis the Invention Mobile application will instantly update all the contacts with the new number in all their smartphone devices directly by replacing the old number. A push notification will alert the users that there has been a change in their contacts. This is done through a database update and refresh of all the contacts that contain the smartphone user's phone number. The search in the database will find the Old number, and replace with the new number within the user's contact group. Since the phonebook is updated, all the user's contacts will continue to make phone calls to the user as usual. For the users that are not in the internet range or offline, the Invention mobile application will sync the contacts with the server database once they are exposed to the Internet. Once the phonebook is updated in the smartphone, tablet or Computer, the entire user's accounts linked with their phone number such as Google drive, iCloud etc will be instantly synchronized based on their phone settings. Other Mobile Apps that interfaces with the users phonebook will also be synchronized with the new number based on the individual Apps settings.

Assign Dummy Number—When the user decides that a particular contact(s) is no longer needed, the present invention has a feature to assign a ‘Dummy Number—9999999999’. Using this feature as specified in Diagram 2, it replaces the user's current phone number with ‘9999999999’. It can be done by the user for one or more contact(s). Upon assigning the dummy number, the contact(s) will no longer be able to connect with the user, as the phonebook in the smartphone is directly updated by replacing the user's phone number with the dummy number.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method enabling users to instantly update the phone number to all the stored contacts by replacing the old number through App as medium with push notification service comprising:
1) Deleted.
2) Deleted.
3) to assign a dummy number (9999999999) when the contact is not needed to store the user's phone number, once the dummy number (9999999999) is assigned to the selected contact(s), the user's phone number will be directly replaced with the dummy number (9999999999) permanently in the phonebook.
4) the users through the App, can update the phone number along with country code in their contact's smartphone or tablet device by replacing the old phone number automatically.
5) A push notification indicating “there's an update or change to your contact(s)”. This is maintained in the database with key ‘0’ and ‘1’ against all user's contacts, wherein ‘0’ refers to pending update when the user is not in the internet range and ‘1’ refers to the successful update when connected to the internet.
6) An ‘Activity Log’ tab with radio button for ‘Changed phone number’ and ‘Dummy number’ displaying updated contacts.
